(19) United States
(12) Patent Application Publication
(10) Pub. No.: US 2003/0083014 A1
(43) Pub. Date: May 1, 2003

(54) Method on cell site selection in a cellular system with interference free window

(75) Inventors: Daoben Li, Beijing (CN); Haiyang Gao, San Jose, CA (US); Shiu Ming Joseph Ho, San Jose, CA (US); Yongsheng Zhang, Beijing (CN); Weidong Chen, San Jose, CA (US); Yuanhua Deng, San Jose, CA (US); Jianming Xu, San Jose, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Linkair Communications, Inc.

(21) Appl. No.: 10/308,674

(22) Filed: Dec. 3, 2002

Related U.S. Application Data
(63) Continuation of application No. PCT/CN00/00138, filed on Jun. 5, 2000.

(51) Int. Cl. H04B 1/10

(52) U.S. Cl. 455/63; 455/65

(57) ABSTRACT

In accordance with the present invention, a method is provided for a mobile station to select one cell site in a plurality of cell sites in cellular systems with an Interference Free Window. This method is based on measurement of the signal on the downlink. In preferred embodiments, a mobile station receives the downlink spread spectrum signals from a plurality of neighboring cells. By using a RAKE type correlator or matched filter, the signal energy and the multipath delay spread profile can be estimated at the mobile station. A new function is defined as the ratio of the multipath delay spread to the energy of the received signal. Minimizing the said function will result in a cell site that provides the best quality of service in a multipath propagation environment.

### CROSS-REFERENCE TO RELATED APPLICATIONS

This is a continuation application of PCT/CN00/00138, filed Jun. 5, 2000, which is incorporated herein by reference in its entirety.

### BACKGROUND OF THE INVENTION

1. Field of the Invention

The present invention relates to a cell site selection method under a wireless communication system, and more particularly, to a method that enables a mobile station to select a target base station for service based on new criterion.

2. Description of the Related Art

In a PCT Application with inventor, number and title of it, respectively, as Li Daoben, PCT-CN00/00028 and “A Scheme for Spread Spectrum Multiple Address Coding with Interference Free Window,” there is disclosed a kind of complementary orthogonal codes, referred to herein as LS codes. The LS codes have an “Interference Free Window” property, which is also referred to as “zero correlation window” property. As an illustration, consider the following four LS codes of length 8:

(C1, S1)=(++−+, +−−−)

(C2, S2)=(+++−, +−++)

(C3, S3)=(−+++, −−+−)

(C4, S4)=(−+−−, −−−+)

The cross-correlation of any two of these codes is zero when the time shift between the two codes is within the (inclusive) window [−1, +1], and the auto-correlation of any of these codes is zero except when there is no time shift. Thus, these four codes have an Interference Free Window of [−1, +1].

Similarly, the following LS codes of length 16 have an Interference Free Window of [−3, +3]:

(C1, S1)=(++−++++−, +−−−+−++)

(C2, S2)=(++−+−−−+, +−−−+−−−)

(C3, S3)=(+++−++−+, +−+++−−−)

(C4, S4)=(+++−−−+−, +−++−+++)

If only (C1, S1) and (C2, S2) are considered, they have an Interference Free Window of [−7, +7].

Thus, when remote units transmit to a base station signals that are modulated using a set of LS codes that have a Interference Free Window of [−n, +n], these signals will not interfere with each other as long as they arrive at the receiving base station within n chips with respect to each other. This eliminates inter-symbol interferences and multiple access interferences when multipath signals from a same remote unit and signals from different remote units arrive within an Interference Free Window.

In a wireless cellular communication network, a mobile station may have access to a number of possible cell sites and a choice as to which cell site it should communicate with must be made based upon some criteria.

In the prior art of CDMA cellular systems, the mobile station measures the energy level of the signals from different cell sites, and selects the cell site with the biggest energy level as its serving cell site.

Such a cell site selection method does not fit for the cellular systems using spread codes that have the Interference Free Window property, hereinafter also referred to as cellular systems with Interference Free Window. This is because in such a cellular system, the multipath delay spread will greatly affect the system performance.

Therefore, in cellular systems with Interference Free Window, a new method is needed that allows a mobile station to select its serving base station from a plurality of neighboring cells.

The present invention is to propose a scheme for cell selection for cellular systems using spread codes that have Interference Free Window property.

### BRIEF SUMMARY OF THE INVENTION

It is an object of the present invention to provide a cell site selection method for cellular wireless systems that employ spread codes with Interference Free Window.

It is a further object of the present invention to provide a cell site selection method, so that the cellular systems could more efficiently use the Interference Free Window property of the spread codes.

It is yet another object of the present invention to provide a cell site selection scheme that employs a multipath delay spread profile in a spread spectrum wireless system.

In accordance with the present invention, as embodied and broadly described herein, a method is provided for a mobile station to select one cell site in a plurality of cell sites in the cellular systems with Interference Free Window. This method is based on measurement of the signal on a downlink channel. In preferred embodiments, a mobile station receives the downlink spread spectrum signals from a plurality of neighboring cells. By using a RAKE type correlator or matched filter, the signal energy and the multipath delay spread profile can be estimated at the mobile station. A new function is defined as the ratio of the multipath delay spread to the energy of the received signal. Minimizing the said function will result in a cell site that provides the best quality of service in a multipath propagation environment.

Following the above optimization scheme, a subset of cell sites can be selected iteratively such that it contains M sub-optimal cell sites. This subset is called a candidate set. The serving cell, and the candidate set should be updated at the mobile station based on the current measurement of the signal energy and multipath delay spread of the received signals. This scheme can be used for initial system determination, as well as for handoff in a spread spectrum communication system, particularly a cellular system with Interference Free Window.

### BRIEF DESCRIPTION OF THE ATTACHED DRAWINGS

The accompanying drawings, which are incorporated into and constitute a part of this specification, illustrate particular embodiments of the invention, and together with the description, serve to explain, but not restrict, the principles of the invention.

FIG. 1 shows a typical cellular wireless network where a mobile station attempts to initiate communication with a base station according to an embodiment of the present invention.

FIG. 2 shows an exemplary flow chart for system determination in a cellular system with Interference Free Window according to an embodiment of the present invention.

FIG. 3 illustrates an example of the auto-correlation output from a matched filter where the main-lobe represents the signal energy according to an embodiment of the present invention.

FIG. 4 illustrates that in a multipath delay spread environment, using a Rake type receiver can lock onto different multipath signal components. If a time reference is provided, then different multipath components can be separately identified as distinct echoes of the signal separated in time. The multipath delay spread profile on the downlink channels can then be estimated according to an embodiment of the present invention.

FIG. 5 shows an exemplary processing flowchart of the cell selection according to an embodiment of the present invention.

### DETAILED DESCRIPTION OF THE INVENTION

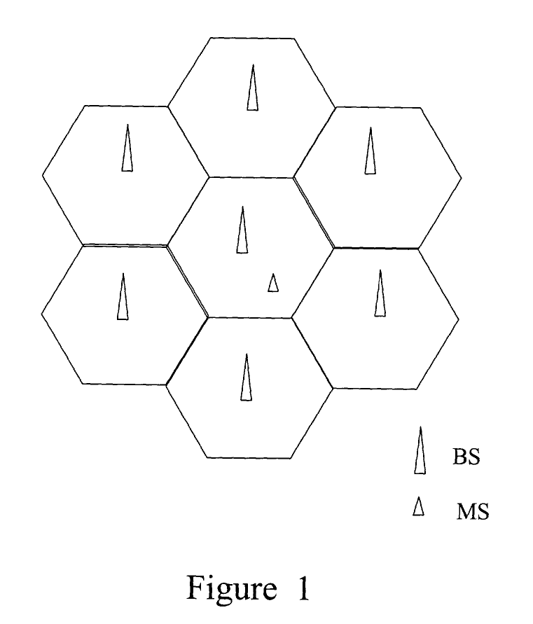

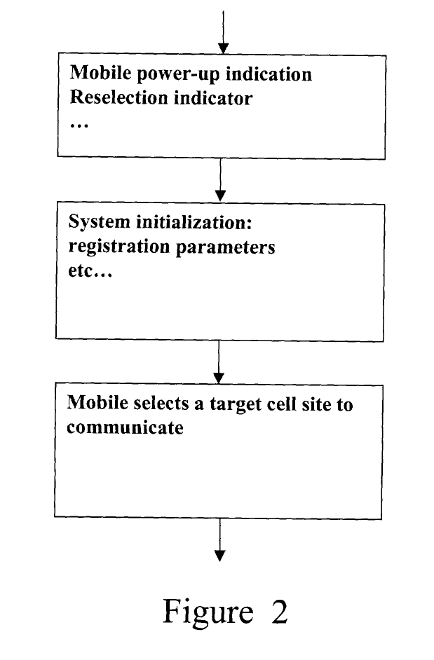

A preferred embodiment of the present invention, as shown FIG. 1, includes a mobile station and a plurality of N base stations, B={BS1,BS2, . . . ,BSn}, corresponding to N neighboring cell sites. As illustrated, by way of example, N=7 is typical for a cellular wireless network. Similar to a traditional CDMA network like IS-95, there are several states during call processing that will enter to a mobile initialization state, (e.g. the mobile station is in the power-up stage). As outlined in FIG. 2, upon entering this state, the mobile station shall initialize registration parameters. It will then select a serving base station, and achieve downlink synchronization accordingly.

In cellular systems with Interference Free Window, a base station within each cell transmits signals on a downlink channel to a plurality of mobile stations. The downlink channel of each base station is spread by a spreading code. To reduce the adjacent cell interference, different base stations in different, nearby cells should use different spreading codes for this channel, for example, LS codes as disclosed in a PCT Application with the application number PCT-CN00/00028. If there are N nearby base stations in a given cellular network configuration, generally there are N spreading codes, {C1,C2, . . . ,Cn}, for different base station in each cell site. For example, there are at least 7 codes, {C1,C2, . . . ,C7), for the cellular network depicted in FIG. 1.

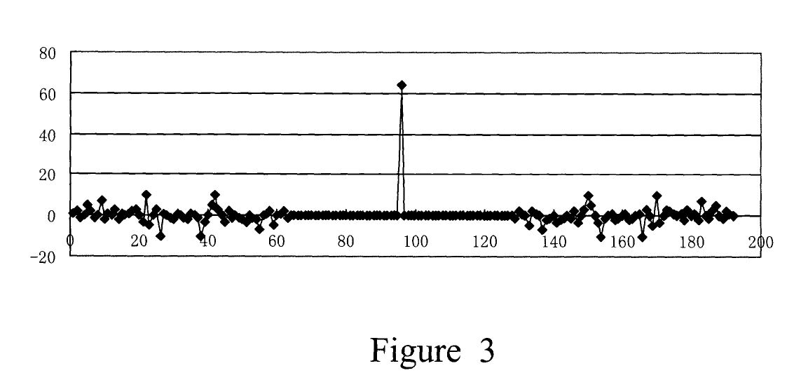

In general, the receiver of a mobile station employs a correlator, or alternatively, a matched filter for demodulation and de-spreading of the forward sync channel signals. The mobile station shall receive signals from the base stations {BS1, . . . ,BSn} via each downlink channel having spreading code, {C1, . . . ,Cn}, respectively. As the result of correlation computation, the energy of the received signals can be estimated, as the main lobe of the auto-correlation function. FIG. 3 shows an example of a resultant auto-correlation function for spreading code Ck, corresponding to base station BSk. The peak of the main lobe represents the energy of the signal transmitted from the base station BSk. Following this way, the energy level of the transmitted signals from the base stations can be obtained, and is denoted by E={E1, . . . ,En}.

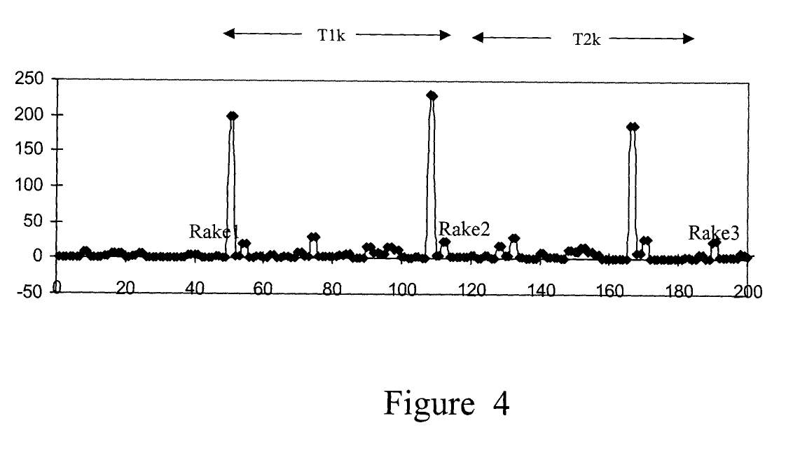

On the other hand, in a multipath time delay spread environment, taking into account the multipath delay spread profile can optimize cell site selection. It is well known that a RAKE correlator, or a RAKE matched filter uses different rakes to lock onto multipath signal components, separated by certain time delay. Therefore, unlike in IS-95 where rakes are only used to produce a combined signal, the output of a RAKE type receiver also tracks the time delay information between the arrivals of each path. FIG. 4 gives an example of the output from a RAKE type receiver with three rakes. For the spreading code Ck, the time delay between each path is obtained and denoted as Tk={T1k,T2k}. Thus, the multipath delay spread profiles in terms of different cells can be obtained and denoted as T={T1, . . . ,Tn} accordingly.

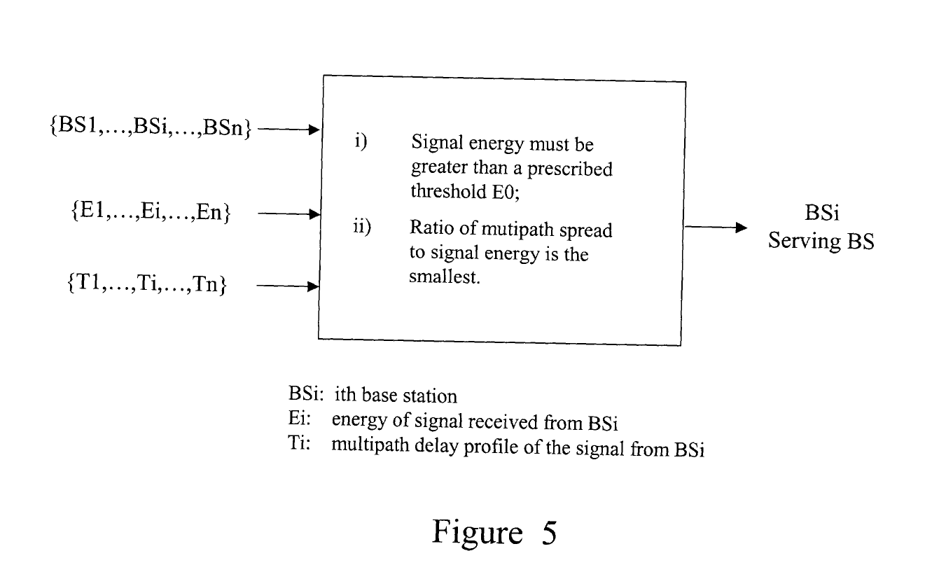

Given the signal strength E={E1, . . . ,En}, and the delay spread profile T={T1, . . . ,Tn}, of the said base stations, a scheme can be developed to determine a set of base stations that provide the best performance in terms of the {E, T} profile. First, only the base stations having their signal energy above certain prescribed threshold, say for example, E0, are considered for selection. Secondly, a function is defined and evaluated as the ratio of the multipath delay spread to the energy level of the received signal. Therefore, the serving base station can be selected such that the said ratio of the received signal from the base station is the smallest. FIG. 5 illustrates the processing diagram of this cell selection scheme.

Using this scheme iteratively, a subset of a plurality of the base stations is derived. This subset is called a candidate set such that it contains the best candidates of base stations to which the said mobile station may communicate. Note that the said candidate set should be updated with the current evaluation based on the signal energy and the multipath delay spread profile at the said mobile station.

The preferred embodiment of a cell selection scheme comprises the following steps:

a plurality of base stations transmit a signal on downlink via a forward sync channel which uses different spreading codes for each base station;

a mobile station receives multiple signals from a plurality of nearby base station;

the receiver of the said mobile station estimates the energy of each received signal from different base stations. The received signals with the energy level lower than a prescribed threshold will not be considered in cell selection;

the receiver also tracks the arrival time delay of each path in a multipath propagation environment for the signals received from different base stations;

the ratio of the multipath delay to the energy of the received signals is evaluated.

The serving base station is selected as the one having the smallest ratio. Similarly, a subset of base stations can be determined as the possible candidates for a mobile station.

The mobile station can update its serving base station and the candidate set in Step 5 with the current measurement of the received signals.

It will be apparent to those skilled in the art that various modifications can be made to the present cell selection method without departing from the scope and spirit of the present invention. It is intended that the present invention covers modifications and variations of the systems and methods provided they fall within the scope of the claims and their equivalents. Further, it is intended that the present invention cover present and new applications of the system and methods of the present invention.

What is claimed:

1. A method of assigning a remote unit to a particular cell site in a plurality of nearby cell sites in a cellular system, wherein the said cellular system uses spreading codes that have an Interference Free Window property, comprising the following steps:
measuring with the remote unit the signal energy and the multipath delay spread profile of signals received from a plurality of base stations corresponding to different cell sites; and
selecting with the remote unit the particular cell site in an integrative consideration that the selected cell should have an energy level as big as possible and a multipath delay spread as narrow as possible.

2. The method of claim 1, wherein the selection of a particular cell site further comprises the following steps:
said remote unit calculates a function value of each cell in accordance with a predefined function of the energy level and the multipath delay spread from each of the plurality of base stations corresponding to different cell sites;
said remote unit selects the cell site with the best function value as its serving cell.

3. The method of claim 2, wherein in the predefined function, the energy level and the multipath delay spread have opposite effects on the value of said predefined function.

4. The method of claim 2, wherein the said predefined function contains a ratio of the multipath delay spread to the energy level of the received signal.

5. The method of claim 2, wherein the said predefined function is a ratio of the multipath delay spread to the energy level of the received signal, and the best function value is the smallest function value.

6. The method of claim 1, further comprising the following step:
the remote unit abandons the cell sites if their measured energy levels are below a predetermined threshold.

7. The method of claim 2, further comprising the following step:
the remote unit abandons the cell sites if their measured energy levels are below a predetermined threshold.

8. The method of claim 1, further comprising the following step:
said remote unit selects a plurality of cell sites as candidate set of cell sites.

9. The method of claim 8, wherein the said remote unit selects the said candidate set of cell sites in an integrative consideration on the energy level and the multipath delay spread.

10. The method of claim 8, wherein the said candidate set is updated according to the current measurement of the received signals.

11. The method of claim 2, further comprising the following step:
said remote unit selects a plurality of cell sites as candidate set of cell sites.

12. The method of claim 11, wherein the said remote unit selects the said candidate set of cell sites in an integrative consideration on the energy level and the multipath delay spread.

13. A method of claim 11, wherein the said candidate set is updated according to the current measurement of the received signals.

14. The method of claim 1, wherein the said particular cell site is updated according to the current measurement of the received signals.

15. The method of claim 2, wherein the said particular cell site is updated according to the current measurement of the received signals.

16. The method of claim 1, further including the steps of:
receiving at a receiver of the said remote unit estimates the energy of each received signal from different base stations, while the received signals with the energy level lower than a prescribed threshold will not be considered in cell selection;
tracking with the receiver an arrival time delay of each path in a multipath propagation environment for the signals received from different base stations; and
evaluating a ratio of the multipath delay to the energy of the received signals, while the serving base station is selected as the one having the smallest ratio, similarly, a subset of base stations is determined as the possible candidates for a remote unit.

17. The method of claim 16, further comprising the following step:
updating its serving base station and the said candidate set of the remote unit with the current measurement of the received signals.
